(19) United States
(12) Patent Application Publication
(10) Pub. No.: US 2021/0214230 A1
(43) Pub. Date: Jul. 15, 2021

(54) PURIFICATION OF FIBROUS CARBON NANOHORN AGGREGATE

(71) Applicant: NEC CORPORATION, Tokyo (JP)

(72) Inventor: Mayumi KOSAKA, Tokyo (JP)

(73) Assignee: NEC CORPORATION, Tokyo (JP)

(21) Appl. No.: 17/044,069

(22) PCT Filed: May 1, 2018
(86) PCT No.: PCT/JP2018/017414

§ 371 Date: Sep. 30, 2020

(51) Int. Cl. C01B 32/18; C09C 1/44; H01B 1/04

(52) U.S. Cl. CPC C01B 32/18; C09C 1/44; H01B 1/04; C01P 2006/40; C01P 2004/61; C01P 2006/80; C01P 2004/03; C01P 2004/50

(57) ABSTRACT

The purpose of the present invention is to provide a carbon mixture having high electrical conductivity. A carbon mixture according to the present invention is characterized by including a fibrous carbon nanohorn aggregate having a length of 1 μm or more in an amount of 20 wt % or more.

### TECHNICAL FIELD

The present invention relates to a carbon mixture containing a fibrous carbon nanohorn aggregate and a method for separating and purifying a fibrous carbon nanohorn aggregate.

### BACKGROUND ART

The single-layer carbon nanohorn is a cone-shaped carbon structure in which the tip of a structure in which a graphene sheet is wound is sharpened in an angle (horn) shape with a tip angle of about 20°. Patent Document 1 describes a single-layer carbon nanohorn. As described in Patent Document 1, usually, single-layer carbon nanohorns are aggregated radially with a conical tip end facing outward to form a spherical carbon nanohorn aggregate having a diameter of about 100 nm. FIG. 3 of Patent Document 1 shows a TEM photograph of a spherical carbon nanohorn aggregate, and its structure can be confirmed.

The single-layer carbon nanohorn is formed of one graphene sheet and is considered to have high conductivity. In the spherical carbon nanohorn aggregate, single-layer carbon nanohorns are partially chemically bonded, and similarly, it is considered that the conductivity is high. However, the contact resistance among the spherical carbon nanohorn aggregate is large, and sufficient conductivity cannot be obtained with the spherical carbon nanohorn aggregate.

A carbon material such as carbon nanotube having a needle-like structure has a high effect of imparting conductivity because it can form a conductive path of about several μm, but it has poor dispersibility and is difficult to use as a material. In addition, when dispersed with strong ultrasonic waves, there is a problem that defects increase and conductivity decreases.

In recent years, unlike a spherical carbon nanohorn aggregate, a fibrous carbon nanohorn aggregate having a structure in which single-layer carbon nanohorns are radially aggregated and extended in a fiber-form has been discovered. Patent Document 2 describes a fibrous carbon nanohorn aggregate. The fibrous carbon nanohorn aggregate is a fibrous carbon structure having a diameter of 30 nm to 200 nm and a length of 1 μm to 100 μm. On the surface of the fibrous carbon nanohorn aggregate, projections of a single-layer carbon nanohorn having a diameter of 1 nm to 5 nm and a length of 30 nm to 100 nm are provided. The fibrous carbon nanohorn aggregate has high conductivity because the single-wall carbon nanohorns having high conductivity are connected in a fibrous shape and are characterized by a structure having a long conductive path. Furthermore, the fibrous carbon nanohorn aggregate has high dispersibility, and is highly effective in imparting conductivity as a material as well.

### CITATION LIST

### Patent Literature

Patent Literature 1: Japanese Patent Laid-Open No. 2001-64004

Patent Literature 2: Japanese Patent No. 6179678

### SUMMARY OF INVENTION

### Technical Problem

The fibrous carbon nanohorn aggregate is prepared by evaporating the catalyst-containing carbon target by laser ablation while rotating the catalyst-containing carbon target in an inert gas or nitrogen gas as described in Patent Document 2. This product is a carbon mixture containing fibrous carbon nanohorn aggregate, spherical carbon nanohorn aggregate, and graphite.

In the carbon mixture, when the fibrous carbon nanohorn aggregate is present in a small amount and the spherical carbon nanohorn aggregate and graphite are present in a large amount, the long conductive paths of the fibrous carbon nanohorn aggregate are reduced. That is, when the amount of fibrous carbon nanohorn aggregate is small, the conductivity of the carbon mixture is low, and when the amount of fibrous carbon nanohorn aggregate is large, the conductivity of the carbon mixture is high. If the content of the fibrous carbon nanohorn aggregate can be adjusted, desired conductivity can be obtained.

However, the content of the fibrous carbon nanohorn aggregate in the carbon mixture obtained by the method described in Patent Document 2 was as small as several wt %. Furthermore, no method has been disclosed hitherto for increasing the content of the fibrous carbon nanohorn aggregate in the carbon mixture. Therefore, it was not possible to obtain a carbon mixture having high conductivity.

The objective of the present invention is providing the carbon mixture which has high electroconductivity in view of the problem mentioned above.

### Solution to Problem

The first carbon material of the present invention is characterized by comprising a fibrous carbon nanohorn aggregate having a length of 1 μm or more in an amount of 20% by weight or more.

### Advantageous Effects of Invention

According to the present invention, a carbon mixture having high conductivity can be provided.

### BRIEF DESCRIPTION OF DRAWING

FIG. 1 is a process flow figure of the method concerning this embodiment.

FIG. 2 is a SEM photograph of the unpurified carbon mixture obtained by laser ablation.

FIG. 3 is a SEM photograph of the unpurified carbon mixture obtained by laser ablation.

FIG. 4 is a particle size distribution measurement result of the carbon mixture after graphite removal by a dynamic light scattering method.

FIG. 5 is a particle size distribution measurement result of the refined carbon mixture by the dynamic light scattering method.

FIG. 6 is an SEM photograph of a purified carbon mixture.

FIG. 7 is a particle size distribution measurement result of the refined carbon mixture by the dynamic light scattering method.

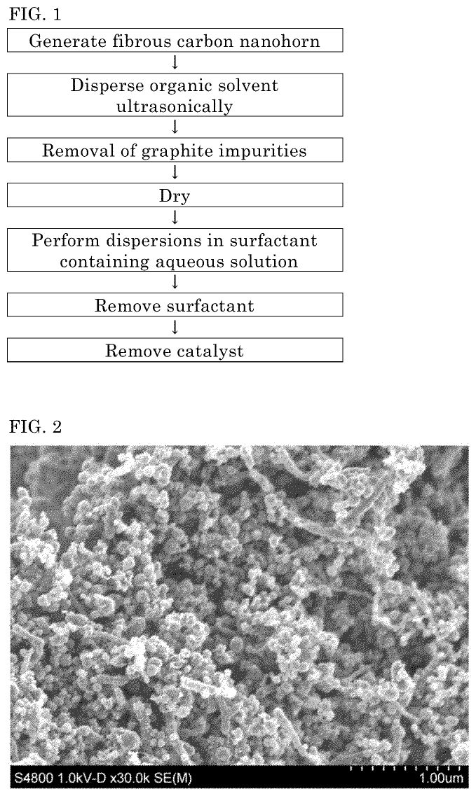

### DESCRIPTION OF EMBODIMENTS

Embodiments of the present invention will be described below. However, the embodiments described below have technically preferable limitations for carrying out the present invention, but the scope of the invention is not limited to the following.

### Carbon Mixture

In the present specification, the term “carbon mixture” refers to a mixture containing carbon materials such as a fibrous carbon nanohorn aggregate, a spherical carbon nanohorn aggregate, and graphite as a main component. Usually, such a carbon mixture is obtained by evaporating a catalyst-containing carbon target by laser ablation while rotating it, and may contain other components such as a catalyst. The total amount of fibrous carbon nanohorn aggregate spherical carbon nanohorn aggregate, and graphite in the carbon mixture is preferably 50% by weight or more, more preferably 70% by weight or more, and may be 100% by weight. According to the method according to the present embodiment, the carbon mixture is refined and the content of the fibrous carbon nanohorn aggregate in the carbon mixture can be increased. In the present specification, a carbon mixture that has not been subjected to any special treatment after laser ablation is referred to as “unpurified carbon mixture”, and a carbon mixture purified by the method according to the present embodiment is referred to as “purified carbon mixture”.

The fibrous carbon nanohorn aggregate is formed by connecting a plurality of single-layer carbon nanohorns in a fibrous shape. Here, the single-walled carbon nanohorn has a conical shape in which the tip of a tubular single-walled carbon nanotube is sharpened in a horn shape, and is composed mainly of carbon atom planes of a graphite structure like carbon nanotubes. Note that, each single-layer carbon nanohorn that constitutes the fibrous carbon nanohorn aggregate is the same as the single-layer carbon nanohorn that constitutes the spherical carbon nanohorn aggregate. In each of the spherical carbon nanohorn aggregate and the fibrous carbon nanohorn aggregate, each of the single-layer carbon nanohorns radially aggregate while projecting horns outwardly. Further, in particular, in the fibrous carbon nanohorn aggregate, the single-layer carbon nanohorns are aggregated and connected in a one-dimensional direction so as to form a fibrous shape while each of the single-layer carbon nanohorns are projecting their tips outwardly and radially. At this time, the fibrous carbon nanohorn aggregate includes at least one kind of carbon nanohorn aggregate structure, selected from a seed type aggregate structure, a bud type aggregate structure, a dahlia type aggregate structure, a petal type (several graphene sheet structure) aggregate structure, and a petal dahlia type (petal type and dahlia type aggregate structure are mixed together). The seed type has a shape in which little or no angular protrusions are observed on the spherical surface. In addition, the bud type is a shape in which some angular projections are seen on the spherical surface. The dahlia type is a shape in which a large number of angular protrusions are seen on a spherical surface. The petal type is a shape in which a petal-shaped protrusion is seen on a spherical surface. The petal dahlia type is an intermediate structure between the dahlia type and the petal type.

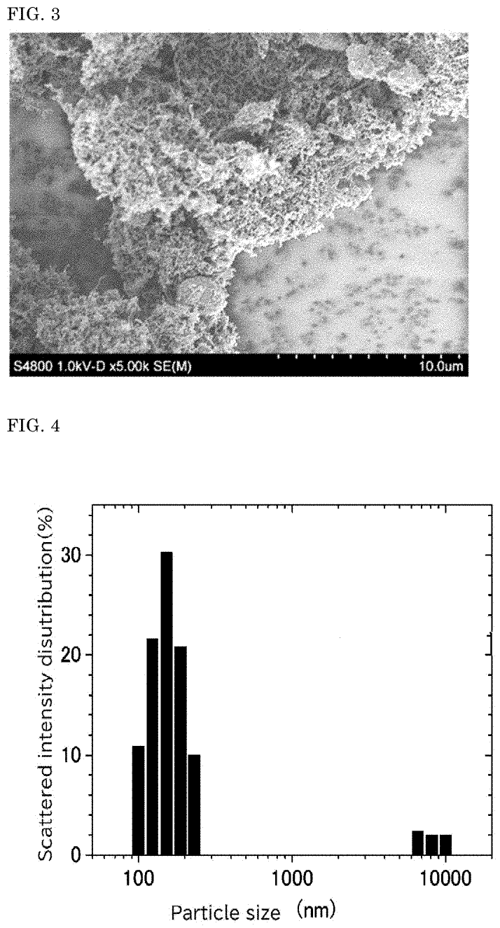

FIG. 2 and FIG. 3 are SEM photographs of an unpurified carbon mixture containing a fibrous carbon nanohorn aggregate, produced by laser ablation. As shown in FIG. 2, the fibrous carbon nanohorn aggregate has a diameter of about 30 nm to 200 nm and a length of about 1 μm to 100 μm. Thus, the fibrous carbon nanohorn aggregate has a length of 1 μm or more. The spherical carbon nanohorn aggregate often observed in FIG. 2 have a diameter of 30 nm to 200 nm and a substantially uniform size. Thus, the spherical carbon nanohorn aggregate have a length of less than 1 μm. As shown in FIG. 3, the unpurified carbon mixture contains graphite, and the size thereof is 1 μm to several tens μm (for example, 50 μm or less).

### Method for Separating and Refining Fibrous Carbon Nanohorn

According to the method of the present embodiment, it is possible to obtain a carbon mixture (refined carbon mixture) containing a high concentration of fibrous carbon nanohorn aggregate from a carbon mixture (particularly unpurified carbon mixture). The method according to this embodiment includes steps 1 to 3. Although Step 2 and Step 3 are continuously performed, Step 1 may be performed before Step 2 or after Step 3. The method according to this embodiment may further include at least one of steps 4 to 6.

### Step 1

In Step 1, graphite is removed from the carbon mixture. Specifically, the carbon mixture is dispersed in an organic solvent, and the graphite is precipitated and separated. When the carbon mixture is dispersed in the organic solvent, graphite precipitates. On the other hand, the fibrous carbon nanohorn aggregate and the spherical carbon nanohorn aggregate have a low density and thus float. By collecting the supernatant of the dispersion together with the suspended solids, the graphite and the carbon nanohorn aggregate (fibrous carbon nanohorn aggregate and spherical carbon nanohorn aggregate) can be separated. The solvent is preferably removed from the recovered supernatant liquid for further processing in other steps. The method for removing the solvent is not particularly limited, and for example, the solvent may be removed by heating.

The organic solvent preferably has a lower density than graphite. The density of the organic solvent is preferably less than 1 g/cm³, more preferably less than 0.8 g/cm³. Examples of such an organic solvent include ethanol and 2-propanol. It becomes difficult to separate graphite in a solvent having a relatively high density such as an aqueous solvent. Further, since graphite has a size of 1 μm to 100 μm, which is about the same size as the fibrous carbon nanohorn aggregate, they cannot be separated by a filter. The dispersion liquid can be prepared, for example, by ultrasonic dispersion. The resulting dispersion is allowed to stand or centrifuge to precipitate only graphite, and the solid content floating in the dispersion is collected to obtain a carbon mixture from which graphite has been removed.

### Step 2

In step 2, the carbon mixture is dispersed in the surfactant solution to prepare a dispersion liquid. When the carbon mixture is dispersed in the surfactant solution, the surfactant is attached to the periphery of the monodispersed fibrous carbon nanohorn aggregate or spherical carbon nanohorn aggregate to form micelles. The spherical carbon nanohorn aggregate and the fibrous carbon nanohorn aggregate are dispersed in the surfactant solution, and almost nothing precipitates.

The surfactant may be one that spreads in a film form on the carbon nanohorn aggregate in order to prevent aggregation of the carbon nanohorn aggregate. Examples of the surfactant include nonionic surfactants such as Polyoxyethylene stearyl ether (Brij), and ionic surfactants such as sodium dodecyl sulfonate (SDS), sodium dodecylbenzene sulfonate (SDBS), sodium cholate (SC), and sodium deoxycholate (DOC). The solvent is not particularly limited, but water or a mixed solvent containing water is preferable.

### Step 3

In Step 3, the fibrous carbon nanohorn aggregate are separated from the dispersion liquid produced in Step 2 with a filter. That is, the spherical carbon nanohorn aggregate and the fibrous carbon nanohorn aggregate dispersed in the dispersion are separated by a filter. Spherical carbon nanohorn aggregate having a diameter of about 100 nm pass through the filter, and fibrous carbon nanohorn aggregate having a length of 1 μm or more and graphite cannot pass through the filter. This allows the spherical carbon nanohorn aggregate to be separated from the fibrous carbon nanohorn aggregate and graphite. The filter separation of step 3 is effective for the surfactant coated carbon mixture formed in step 2. However, when it is not treated with the surfactant, the carbon mixture aggregate on the filter, and the spherical carbon nanohorn aggregate do not pass through the filter and cannot be separated.

Examples of the filter include a membrane filter and filter paper. The filter may be incorporated in the module and used in the form of a cross filter, a syringe filter or the like. The pore size of the filter is preferably 0.1 μm to 1 μm, more preferably 0.2 μm to 0.7 μm. A filter having such a pore size is suitable for separating a spherical carbon nanohorn aggregate from a fibrous carbon nanohorn aggregate. The filters may be used alone or in combination of two or more. Filters having different pore sizes may be used in combination.

The residue on the filter is a carbon mixture containing a high concentration of fibrous carbon nanohorn aggregate, but may also include spherical carbon nanohorn aggregate. The residue may be filtered again to further increase the ratio of the fibrous carbon nanohorn aggregate. By ultrasonically irradiating the residue with the filter in a surfactant solution, the residue can be redispersed in the solution from the top of the filter. The dispersion is filtered again. Thus, the ratio of the fibrous carbon nanohorn aggregate can be increased by performing the filter separation a plurality of times.

In step 3, the ratio of the fibrous carbon nanohorn aggregate in the finally obtained purified carbon mixture can be adjusted according to the purpose of use. For example, the ratio of the fibrous carbon nanohorn aggregate in the purified carbon mixture can be controlled by the filter separation time, the number of filter separations, the filter pore size, and the like. This can increase the weight ratio or volume ratio of the fibrous carbon nanohorn aggregate to the spherical carbon nanohorn aggregate in the purified carbon mixture. The weight ratio or volume ratio (fibrous carbon nanohorn aggregate spherical carbon nanohorn aggregate) of the fibrous carbon nanohorn aggregate to the spherical carbon nanohorn aggregate in the purified carbon mixture is preferably ⅕ or more, more preferably ¼ or more, more preferably ½ or more.

### Step 4

The method according to the present embodiment may further include Step 4 of removing the surfactant from the fibrous carbon nanohorn aggregate obtained in Step 3. Step 4 is carried out after step 3, preferably immediately after step 3. The purified carbon mixture containing the fibrous carbon nanohorn aggregate obtained in step 3 at a high concentration is covered with a surfactant, and this is removed in order to utilize the conductivity of the fibrous carbon nanohorn aggregate. Examples of the method for removing the surfactant include washing with an organic solvent and thermal decomposition. Examples of the organic solvent include 2-propanol and the like. By performing step 4, a purified carbon mixture containing a high concentration of fibrous carbon nanohorn aggregate not covered with a surfactant can be obtained. The purified carbon mixture may be redispersed in a solvent such as ethanol, depending on the application.

### Step 5

The method according to the present embodiment may further include Step 5 of removing the catalyst from the carbon mixture, particularly the fibrous carbon nanohorn aggregate. The timing of carrying out step 5 is not particularly limited, and may be carried out, for example, prior to all steps, or after all steps have been completed. By performing the step 5, it is possible to obtain a purified carbon mixture from which a catalyst (for example, a metal such as Fe, Ni, or Co) is removed. Acids such as nitric acid, sulfuric acid and hydrochloric acid can be used for removing the catalyst. In particular, hydrochloric acid is suitable among these because it is easy to handle. In order to remove the catalyst sufficiently, it is desirable to perform heating at 70° C. or higher. When the catalyst is covered with a carbon coating, it is desirable to perform a pretreatment of heating the carbon mixture in air at about 250° C. to 450° C., for example.

### Step 6

The method according to the present embodiment may further include Step 6 of forming an opening in the fibrous carbon nanohorn aggregate. The timing of carrying out step 6 is not particularly limited, and may be carried out, for example, before all the steps or after all the steps are completed. By heating in an acid or oxygen, a plurality of defects such as a defect having a dangling bond or a defect having a functional group can be formed on the surface of the fibrous carbon nanohorn aggregate. These defects have the effect of making the fibrous carbon nanohorn aggregate hydrophilic and facilitating to support other substances. Examples of the acid include hydrogen peroxide and nitric acid. The heating temperature is preferably in the range of room temperature to 100° C.

In a case of a carbon nanotube, if defects are introduced therein, there arises a problem that conductivity of the carbon nanotube is lowered. On the other hand, in a case of the fibrous carbon nanohorn aggregate, even if the nanohorn portion is damaged and defects are introduced in its graphene sheet, since the surface area of the nanohorn portion is large due to the radial structure, the influence on the overall conductivity is small.

### Purified Carbon Mixture

In the purified carbon mixture obtained by the method according to the present embodiment, the content of fibrous carbon nanohorn aggregate is significantly increased, and the contents of spherical carbon nanohorn aggregate and graphite are significantly reduced. In the present embodiment, the content of the fibrous carbon nanohorn aggregate in the purified carbon mixture is 20% by volume or more or 20% by weight or more. By increasing the content of the fibrous carbon nanohorn aggregate to 20% by volume or more or 20% by weight or more, the conductivity effect can be greatly improved. The content of the fibrous carbon nanohorn aggregate in the purified carbon mixture is preferably 50% by volume or more or 50% by weight or more, more preferably 70% by volume or more or 70% by weight or more, and 100% by volume (100% by weight).). In the present embodiment, the content of the spherical carbon nanohorn aggregate in the purified carbon mixture is preferably 50% by volume or less or 50% by weight or less, more preferably 30% by volume or less or 30% by weight or less, further preferably 10% by volume or less or 10% by weight or less, and may be 0% by volume (0% by weight). In the present embodiment, the content of graphite in the purified carbon mixture is preferably 10% by weight or less, more preferably 5% by weight or less, still more preferably 1% by weight or less, and may be 0% by weight. When step 5 is carried out, the content of the catalyst can be reduced. In the present embodiment, the content of the catalyst in the purified carbon mixture is preferably 10% by weight or less, more preferably 5% by weight or less, still more preferably 1% by weight or less, and may be 0% by weight. Depending on the analysis method, the content may be expressed in volume %. The volume ratio can be converted into a weight ratio based on the density of the constituent components. The fibrous carbon nanohorn aggregate and the spherical carbon nanohorn aggregate have almost the same density. The density of the catalyst is about 6 times that of both carbon nanohorn aggregate. The density of graphite is about 1.6 times that of both carbon nanohorn aggregate.

The graphite content can be analyzed by, for example, thermogravimetric analysis or SEM observation. In thermogravimetric analysis, graphite has a higher combustion temperature than fibrous and spherical carbon nanohorn aggregate.

The content ratio of the fibrous carbon nanohorn aggregate and the spherical carbon nanohorn aggregate can be analyzed by measuring the particle size distribution by the dynamic light scattering method. The spherical carbon nanohorn aggregate has a particle size distribution in the region of 100 nm to 600 nm. The fibrous carbon nanohorn aggregate has a particle size distribution in the region of 1 to 10 μm. Graphite is also detected in the region of 1 to 10 μm in the particle size distribution measurement. In the particle size distribution measurement, a dispersion liquid of a carbon mixture is used as a measurement sample. If the concentration of the dispersion is high, the fibrous carbon nanohorn aggregate may not be detected, and the solid content concentration of the dispersion is preferably

The fibrous carbon nanohorn aggregate has high dispersibility even at high concentration. In a carbon mixture containing a high concentration of fibrous carbon nanohorn aggregate, long conductive paths are increased, and the effect of imparting conductivity can be dramatically enhanced.

The method according to the present embodiment is effective for any fibrous carbon nanohorn aggregate or spherical carbon nanohorn aggregate of seed type, bud type, dahlia type, petal type, and separation and purification can be performed by the same method.

### Examples

Hereinafter, Examples of the present embodiment will be described in detail, but the present embodiment is not limited only to Examples below.

### Example 1

### Preparation of Unpurified Carbon Mixture

A carbon target containing iron was subjected to CO₂ laser ablation in a chamber under a nitrogen atmosphere to prepare an unpurified carbon mixture. Specifically, a graphite target containing 1% by weight of iron was rotated at 2 rpm and continuously irradiated with a CO₂ laser. The energy density of the CO₂ laser was 50 kW/cm². The temperature in the chamber was room temperature, and the flow rate of nitrogen supplied to the chamber was adjusted to 10 L/min. The pressure in the chamber was controlled to 933.254 to 1266.559 hPa (700 to 950 Torr).

FIG. 2 is a SEM photograph of a unpurified carbon mixture produced by laser ablation. The fibrous substance (fibrous carbon nanohorn aggregate) had a diameter of about 30 to 100 nm and a length of several μm to several tens of μm. Most of the spherical substances (spherical carbon nanohorn aggregate) had a substantially uniform size in the diameter range of 30 to 200 nm. From the SEM photograph, it was observed that the fibrous carbon nanohorn aggregate were present, but most of them were spherical carbon nanohorn aggregate. As shown in FIG. 3, the unpurified carbon mixture contained graphite and had a size of 1 μm to several tens of μm.

Thermogravimetric analysis was performed on the obtained unpurified carbon mixture. The fibrous carbon nanohorn aggregate and the spherical carbon nanohorn aggregate burned at about 560° C., and the graphite burned at about 640° C. As a result of thermogravimetric analysis, it was found that the amount of graphite in the unpurified carbon mixture was about 20% by weight.

### Step 1

The unpurified carbon mixture was ultrasonically dispersed in ethanol, the dispersion was allowed to stand for 1 day, and about 50% of the supernatant was collected. The supernatant was dried in an oven at 150° C. to obtain a solvent-free carbon mixture from which graphite was removed. Table 1 shows the results of thermogravimetric analysis of the unpurified carbon mixture and the carbon mixture from which graphite was removed. By collecting the supernatant, it was confirmed that graphite was removed from the unpurified carbon mixture. When the carbon mixture from which graphite was removed was observed by SEM, graphite was not observed and a large amount of spherical carbon nanohorn aggregate and a small amount of fibrous carbon nanohorn aggregate were observed.

TABLE 1

| | Unpurified | Carbon mixture |
|---|---|---|
| | carbon | after removing |
| | mixture | graphite |
| Spherical carbon nanohorn aggregate | 66 | 84 |
| and fibrous carbon nanohorn aggregate | | |
| (weight %) | | |
| Graphite (weight %) | 21 | 0.1 |
| Iron catalyst (oxide) (weight %) | 13 | 16 |

FIG. 4 shows the result of measuring the particle size distribution of the supernatant by the dynamic light scattering method. The supernatant was diluted to a concentration of 0.01 mg/ml, and the concentration was measured using this. As a result, the size distribution of the region of 100 nm to 600 nm and the region of 8 μm to 10 μm was detected. Only spherical carbon nanohorn aggregate and fibrous carbon nanohorn aggregate were observed in this sample from the SEM photograph.

From this size distribution region, it was found that the spherical carbon nanohorn aggregate and the fibrous carbon nanohorn aggregate are in a state of being almost monodispersed in ethanol or dispersed in several aggregate.

Further, from the results of particle size distribution measurement, it was found that the carbon mixture after removal of graphite contained the spherical carbon nanohorn aggregate at a ratio of 94% by volume and the fibrous carbon nanohorn aggregate at a ratio of 6% by volume.

### Step 2

The carbon mixture from which graphite was removed was ultrasonically dispersed in an aqueous solution containing 1% by weight of Polyoxyethylene stearyl ether (Brij). Both the spherical carbon nanohorn aggregate and the fibrous carbon nanohorn aggregate were dispersed in the surfactant solution and did not precipitate.

### Step 3

The dispersion liquid was filtered using a membrane filter (hydrophilic Durapo membrane, material polyvinyllidene fluoride (PVDF)) having a pore size of 0.2 μm to 0.65 μm. The operation of redispersing the residue on the filter and filtering again was repeated several times. Redispersion was performed by irradiating the residue with ultrasonic waves in a surfactant solution together with a filter. By repeating filtration and dispersion, the content ratio of the fibrous carbon nanohorn aggregate increased. It was possible to freely control the ratio of the fibrous carbon nanohorn aggregate by the number of times of filtration and dispersion.

### Step 4

The residue was washed with 2-propanol, pure water, and ethanol on the filter to remove the surfactant. The residue obtained by removing the surfactant together with the filter in ethanol was irradiated with ultrasonic waves to disperse the residue in ethanol.

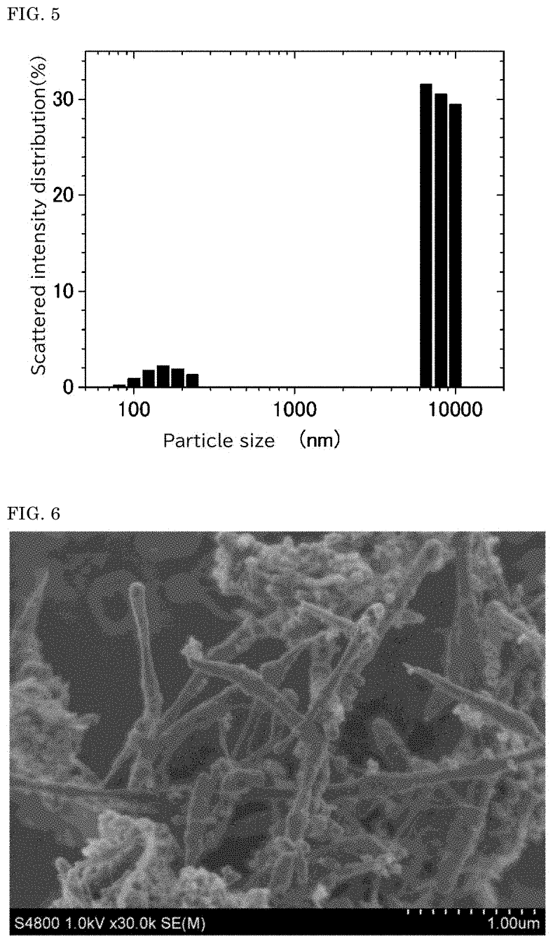

FIG. 5 shows the results of particle size distribution measurement of the ethanol dispersion liquid. A size distribution in the region of 100 nm to 600 nm and the region of 8 μm to 10 μm was confirmed. It was found that the ratio of the fibrous carbon nanohorn aggregate increased to 90% by volume or more and the ratio of the spherical carbon nanohorn aggregate decreased to several % by volume.

The ethanol dispersion was dried in a 150° C. oven to obtain a purified carbon mixture. FIG. 6 is an SEM photograph of the purified carbon mixture. It was observed that the fibrous carbon nanohorn aggregate were mainly observed, and the amount of the spherical carbon nanohorn aggregate was significantly reduced as compared with FIG. 2.

The ethanol dispersion was dropped on a silicon substrate and dried to prepare a thin film of a purified carbon mixture having a film thickness of about 0.5 μm. The resistivity of the thin film was measured by four-point probe measurement. For comparison, a thin film of the unpurified carbon mixture used in this example was also prepared and the resistivity was measured. The resistivity was 3.5 Ωcm for the unpurified carbon mixture and 0.3 Ωcm for the purified carbon mixture. From this result, it was confirmed that the carbon mixture having high conductivity can be obtained by increasing the ratio of the fibrous carbon nanohorn aggregate without impairing the conductivity of the fibrous carbon nanohorn aggregate.

### Example 2

Various purified carbon mixtures having different content ratios of the fibrous carbon nanohorn aggregate were prepared in the same manner as in Example 1 except that the number of filtration with the membrane filter in step 2 was changed. Particle size distribution measurement and resistivity measurement were performed in the same manner as in Example 1. Table 2 shows the measurement results. From this result, it was confirmed that the fibrous carbon nanohorn aggregate had a large effect on the conductivity when the content ratio was 20% by volume or more, and the effect was small when the content ratio was less than 20% by volume.

TABLE 2

| Content ratio of the fibrous carbon | |
|---|---|
| nanohorn aggregate (volume %) | Resistivity(Ω cm) |
| 5 | 3.5 |
| 10 | 3.5 |
| 15 | 3.4 |
| 20 | 2.3 |
| 30 | 1.8 |
| 50 | 0.9 |
| 70 | 0.5 |
| 90 | 0.3 |

### Comparative Example 1

The unpurified carbon mixture of Example 1 was ultrasonically dispersed in ethanol, the dispersion was allowed to stand for 1 day, and about 50% of the supernatant was recovered.

The supernatant was filtered using a membrane filter (hydrophilic Durapo membrane, material PVDF) having a pore size of 0.65 μm. Only ethanol passed through the filter, leaving all solids on the filter.

### Comparative Example 2

The unpurified carbon mixture of Example 1 was ultrasonically dispersed in an aqueous solution containing 1% by weight of Polyoxyethylene stearyl ether (Brij), and the dispersion was allowed to stand for 1 day. About 50% of the supernatant of the dispersion was recovered. When the particle size distribution is measured by the dynamic light scattering method for the dispersion liquid immediately after ultrasonic dispersion and the supernatant liquid collected after standing, the size distribution is similarly detected in the 100 nm to 600 nm region and the 8 to 10 μm region. It was found that the graphite was not separated.

The surfactant was removed by washing the dispersion on a membrane filter with 2-propanol, pure water, and ethanol. When the obtained carbon mixture was observed by SEM, much graphite was observed as in FIG. 3, and it was found that the graphite was not removed.

### Example 3

The unpurified carbon mixture of Example 1 was ultrasonically dispersed in ethanol, the dispersion was centrifuged at about 100 g for 10 minutes, and about 50% of the supernatant was collected. Next, the supernatant was dried in an oven at 150° C., and the obtained carbon mixture was ultrasonically dispersed in an aqueous solution containing 1% by weight of sodium dodecyl benzene sulfate (SDBS). Both the spherical carbon nanohorn aggregate and the fibrous carbon nanohorn aggregate were dispersed in the surfactant solution and nothing precipitated.

This dispersion was treated with a hollow fiber filter (Spectrum Laboratories, Inc. and mPES hollow fiber filter module) having a pore size of 0.2 to 0.65 μm.) were repeatedly circulated through the cross filter to obtain a dispersion liquid that passed through the holes of the hollow fiber filter and a dispersion liquid that did not pass through it.

The dispersion that did not pass through the pores of the hollow fiber filter was washed on the membrane filter with 2-propanol, pure water, and ethanol to remove the surfactant. The residue on the filter from which the surfactant had been removed was irradiated with ultrasonic waves in ethanol to disperse the residue in ethanol.

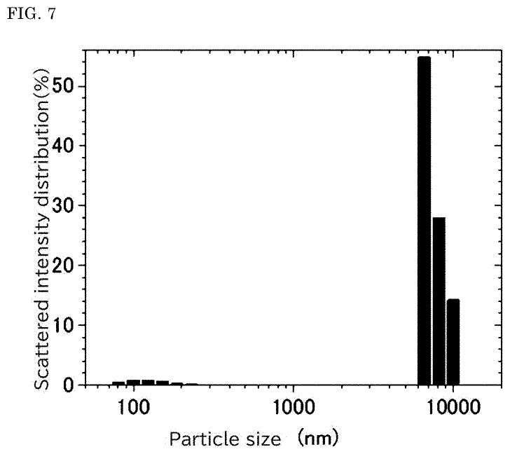

FIG. 7 shows the results of particle size distribution measurement of this ethanol dispersion. It was found that the ratio of the fibrous carbon nanohorn aggregate increased to 90% by volume or more and the ratio of the spherical carbon nanohorn aggregate decreased to several % by volume.

The ethanol dispersion was dried in an oven at 150° C., and the obtained purified carbon mixture was observed by SEM. It was observed that fibrous carbon nanohorn aggregate were mainly observed, and the amount of spherical carbon nanohorn aggregate was significantly reduced.

Moreover, the ratio of the fibrous carbon nanohorn aggregate could be changed by changing the number of times and the time of circulation of the cross filter.

### Example 4

10 mg of the unpurified carbon mixture of Example 1 was dispersed in 200 ml of hydrogen peroxide solution (30%), and heated at 70° C. for 3 hours in a water bath while stirring at 300 rpm with a stirrer. After heating, the dispersion was filtered with a filter having a pore size of 0.2 μm, and the residue on the filter was washed twice with pure water. The residue was then dried in a 100° C. oven for 48 hours. By this treatment, small holes and defects could be formed on the surfaces of the fibrous carbon nanohorn aggregate and the spherical carbon nanohorn aggregate contained in the unpurified carbon mixture.

Graphite was removed in the same manner as in Example 1 from the carbon mixture containing the fibrous carbon nanohorn aggregate in which this defect was produced. Then, the obtained carbon mixture was ultrasonically dispersed in an aqueous solution containing 1% by weight of sodium dodecyl sulfate (SDS) and separated by a filter. The ratio of fibrous carbon nanohorn aggregate in the carbon mixture could be increased significantly.

### Example 5

10 mg of the unpurified carbon mixture of Example 1 was heated in air at 400° C., and then stirred in 200 ml of hydrochloric acid heated to 70° C. for 1 hour twice to remove the contained iron catalyst.

Graphite was removed from the carbon mixture from which the catalyst was removed in the same manner as in Example 1. Then, the obtained carbon mixture was ultrasonically dispersed in an aqueous solution containing 1% by weight of sodium cholate (SC) and separated by a filter. The ratio of fibrous carbon nanohorn aggregate in the carbon mixture could be increased significantly.

### Comparative Example 3

The unpurified carbon mixture of Example 1 was ultrasonically dispersed in ethanol, and about 50% of the supernatant was recovered as in Example 1. Next, the supernatant was divided into two and centrifuged at about 500 g and about 1000 g respectively for 30 minutes to collect the precipitate. When the carbon mixture obtained by drying the precipitate was observed by SEM, fibrous carbon nanohorn aggregate and spherical carbon nanohorn aggregate were observed in both samples in the same manner as before centrifugation. It has been found that the centrifugal separation cannot efficiently separate the fibrous carbon nanohorn aggregate from the spherical carbon nanohorn aggregate.

### Comparative Example 4

The unpurified carbon mixture of Example 1 was ultrasonically dispersed in ethanol, and about 50% of the supernatant was recovered as in Example 1. Next, the supernatant was divided into three and gel filtration chromatography was performed using three kinds of gels (Sephacryl S-300, S-500, S-1000). The dispersion was hardly separated by any of the gel filtration chromatography and dropped at the same time. When the gel filtered dispersion was dried and the resulting carbon mixture was observed by SEM, both fibrous carbon nanohorn aggregate and spherical carbon nanohorn aggregate were observed in the same manner as before gel filtration chromatography. It was found that the fibrous carbon nanohorn aggregate and the spherical carbon nanohorn aggregate cannot be efficiently separated by gel filtration chromatography.

### Example 6

The unpurified carbon mixture of Example 1 was ultrasonically dispersed in an aqueous solution containing 1% by weight of Polyoxyethylene stearyl ether (Brij). This dispersion was subjected to filtration and dispersion several times using a membrane filter having a pore size of 0.2 μm to 0.65 μm as in Example 1. By repeating filtration and dispersion, the ratio of fibrous carbon nanohorn aggregate increased. Since not only the fibrous carbon nanohorn aggregate but also graphite remain on the filter, the filter is likely to be clogged. In order to make the ratio of the fibrous carbon nanohorn aggregate about the same, the number of times of filtration is increased as compared with Example 1.

The surfactant was removed by washing the residue on the filter with 2-propanol, pure water, and ethanol. The residue on the filter from which the surfactant had been removed was irradiated with ultrasonic waves in ethanol to disperse the residue in ethanol.

This dispersion was allowed to stand for 1 day, and about 50% of the supernatant was recovered. The particle size distribution was measured in the same manner as in Example 1. Further, the supernatant liquid was dried to obtain a purified carbon mixture. This was observed by SEM. The results of particle size distribution measurement and SEM observation were the same as in Example 1.

Although the present invention has been described with reference to the exemplary embodiments and examples, the present invention is not limited to the above-described exemplary embodiments and examples. Various changes that can be understood by those skilled in the art can be made to the configuration and details of the present invention within the scope of the present invention.

The whole or part of the exemplary embodiment can be described as, but not limited to, the following supplementary notes.

### Supplementary Note 1

A carbon mixture containing a fibrous carbon nanohorn aggregate having a length of 1 μm or more in an amount of 20% by weight or more.

### Supplementary Note 2

A carbon mixture containing 20% by volume or more of a fibrous carbon nanohorn aggregate having a length of 1 μm or more.

### Supplementary Note 3

A fibrous carbon nanohorn aggregate having a length of 1 μm or more and a spherical carbon nanohorn aggregate having a length of less than 1 μm are included, and a weight ratio of the fibrous carbon nanohorn aggregate to the spherical carbon nanohorn aggregate is included. A carbon mixture that is ⅕ or more.

### Supplementary Note 4

The carbon mixture according to any one of Supplementary Notes 1 to 3, wherein the amount of graphite is 10% by weight or less.

### Supplementary Note 5

The carbon mixture according to any one of Supplementary Notes 1 to 4, which does not contain a catalyst.

### Supplementary note 6

The carbon mixture according to any one of supplementary notes 1 to 5, wherein the fibrous carbon nanohorn aggregate is open.

### Supplementary Note 7

An electrode including the carbon mixture according to any one of Supplementary Notes 1 to 6.

### Supplementary Note 8

A method for separating and purifying a fibrous carbon nanohorn aggregate having a length of 1 μm or more from a carbon mixture, which comprises removing graphite from the carbon mixture, and dispersing the carbon mixture in a surfactant solution. A step 2 of preparing a dispersion, and a step 3 of separating the fibrous carbon nanohorn aggregate from the dispersion with a filter.

### Supplementary Note 9

The method according to Supplementary Note 8, wherein the step 1 is a step of dispersing the carbon mixture in an organic solvent and precipitating and separating the graphite.

### Supplementary Note 10

The method according to Supplementary Note 9, wherein the organic solvent is an organic solvent having a density lower than that of the graphite.

### Supplementary Note 11

The method according to Supplementary Note 9 or 10, wherein the step 1 includes a step of removing the organic solvent.

### Additional remark 12

The method according to any one of additional remarks 8 to 11, wherein the pore size of the filter is 0.1 μm to 1 μm.

### Supplementary note 13

The method according to any one of supplementary notes 8 to 12, further comprising a step 4 of removing the surfactant from the fibrous carbon nanohorn aggregateeparated in the step 3.

### Supplementary Note 14

The method according to Supplementary Note 13, wherein the step 4 is a step of removing the surfactant with an organic solvent or heat.

### Supplementary Note 15

The method according to any one of Supplementary Notes 8 to 14, further comprising a step 5 of removing a catalyst from the fibrous carbon nanohorn aggregate.

### Supplementary note 16

The method according to any one of supplementary notes 8 to 15, further comprising a step 6 of opening the fibrous carbon nanohorn aggregate.

### Industrial Applicability

The carbon mixture according to this embodiment is a material having high conductivity and high dispersibility, adsorptivity, and specific surface area. The carbon mixture according to the present embodiment can be mixed with conductive particles, a curable resin, a curing agent, etc. to prepare a conductive paste. Further, the carbon mixture according to this embodiment can be used as an electrode material, a composite material, a conductive film material, an actuator, a capacitor, and a carrier material.

1. A carbon mixture comprising a fibrous carbon nanohorn aggregate having a length of 1 μm or more in an amount of 20% by weight or more.

2. A carbon mixture comprising a fibrous carbon nanohorn aggregate having a length of 1 μm or more in an amount of 20% by volume or more.

3. The carbon mixture according to claim 1, wherein an amount of graphite is 10% by weight or less.

4. The carbon mixture according to claim 1, which does not contain a catalyst.

5. An electrode comprising the carbon mixture according to claim 1.

6. A method for separating and purifying a fibrous carbon nanohorn aggregate with a length of 1 μm or more from a carbon mixture, comprising:
a step 1 of removing graphite from the carbon mixture,
a step 2 of dispersing the carbon mixture in a surfactant solution to prepare a dispersion, and
a step 3 of separating the fibrous carbon nanohorn aggregate from the dispersion with a filter.

7. The method according to claim 6, wherein the step 1 is a step of dispersing the carbon mixture in an organic solvent and separating the graphite by sedimentation.

8. The method according to claim 6, further comprising the step 4 of removing the surfactant from the fibrous carbon nanohorn aggregate separated in the step 3.

9. The method according to claim 6, further comprising a step 5 of removing a catalyst from the fibrous carbon nanohorn aggregate.

10. The method according to claim 6, further comprising a step 6 of forming an opening in the fibrous carbon nanohorn aggregate.
